(19) United States
(12) Patent Application Publication
(10) Pub. No.: US 2015/0328549 A1
(43) Pub. Date: Nov. 19, 2015

(54) SYSTEM, METHOD, AND STORAGE MEDIUM STORING PROGRAM FOR PROVIDING GAME

(71) Applicant: DeNA Co., Ltd., Tokyo (JP)

(72) Inventor: Shota TANAKA, Tokyo (JP)

(73) Assignee: DeNA Co., Ltd.

(21) Appl. No.: 14/709,450

(22) Filed: May 11, 2015

(30) Foreign Application Priority Data
May 14, 2014 (JP) 2014-100537

(51) Int. Cl. A63F 13/537

(52) U.S. Cl. CPC A63F 13/537

(57) ABSTRACT

A sense of discomfort brought to a user of a game when notification information is presented can be reduced. A system according to an embodiment may include an information storage unit storing various information, a start instruction receiving unit receiving a start instruction to start the game from a user, an event information specifying unit specifying, in response to the reception of the start instruction, one or more pieces of event information occurring as the game progresses, and a notification information specifying unit specifying one or more pieces of notification information including information about services other than the game to be notified to the user. The system may further include an event history presenting unit presenting event history information including the specified event information and the notification information as event histories respectively to the user, and a reward providing unit providing reward to the user.

### CROSS-REFERENCE TO RELATED APPLICATIONS

This application is based on and claims the benefit of priority from Japanese Patent Application Serial No. 2014-100537 (filed on May 14, 2014), the contents of which are hereby incorporated by reference in their entirety.

### TECHNICAL FIELD

The present disclosure relates to a system, method and storage medium storing program for providing a game.

### BACKGROUND

There has been proposed a system to present notification information such as advertisement to a user who plays an on-line game and the like through a computer network (see, for example, Japanese Patent Application Publication No. 2013-214204). According to such a system, banner advertisements and the like are displayed on a part of a display screen of an online game which a user is playing. When the banner advertisements and the like are selected by the user, the user is guided to related web-pages and the like.

However, this system may abruptly display a banner advertisement and the like that less relates to progress of the game, and a user who is focused on playing the game may feel uncomfortable or unpleasant about this. The user may be disinclined to select the banner advertisement and the like to transition to the related web-page and the like. Consequently, it is not possible to achieve high effectiveness of advertisement. As described above, there is a demand for a mechanism which can adequately present notification information such as advertisements to a user who is playing a game without bringing a sense of discomfort to the user.

### SUMMARY

One object of embodiments of the present disclosure is to decrease the sense of discomfort brought to the user of the game when the notification information is presented. Other objects of the embodiments of the present disclosure will be apparent with reference to the entire description in this specification.

According to an embodiment of the disclosure, a system for providing a game to a user includes one or more computer processors configured to execute instructions. The computer processor, in response to execution of the instructions, is configured to: receive an start instruction to initiate the game from the user; specify, in response to reception of the start instruction, one or more pieces of event information occurring in the course of the game; specify one or more pieces of notification information to be notified to the user, the notification information including information about a service other than the game; and present, to the user, event history information including the specified event information and the specified notification information as event histories respectively. Here, the “other service” may include a game other than the game, services which the system according to the embodiment provides, and services which the system according to the embodiment does not provide.

In the system according to the embodiment, the game may be a game using a character, the event information may be information about an event generated for the character, and the event history may be a history relating to the event generated for the character. In such a system according to the embodiment, the character may obtain or consume a game content in the course of the game. The event information may include information about an event in which the character obtain or consume the game content. Here, the “game content” means various types of electronic information having certain values in games. An example of the game content may include points, experience points, coins, items, cards, HP (hit points), MP (magic points), virtual currencies and the like.

The system according to the above-described embodiment may further include a storage device configured to store at least preference information about the user's preference for services. Specifying the notification information may include specifying information about a recommended service which is the other service to be recommended to the user based on the preference information. In the system according to the embodiment, the information about the recommended service may include information notifying to the user that the user has obtained or is capable of obtaining a service content usable in the recommended service. Here, the “service content” means various types of electronic information having certain values in services. An example of the game content may include points, experience points, coins, items, cards, HP (hit points), MP (magic points), virtual currencies, and other various electronic information corresponding to the content of the service.

According to an embodiment of the disclosure, a method using one or more computers for providing a game to a user includes: receiving a start instruction to initiate the game from the user; specifying, in response to reception of the start instruction, one or more pieces of event information occurring in the course of the game; specifying one or more pieces of notification information to be notified to the user, the notification information including information about a service other than the game; and presenting, to the user, event history information including the specified event information and the specified notification information as event histories respectively. Here, the “other service” may include a game other than the game, services which the system according to the embodiment provides, and services which the system according to the embodiment does not provide.

According to an embodiment of the disclosure, a computer-readable storage medium storing a program for providing a game to a user is provided. The program causes one or more computers to: receive a start instruction to initiate the game from the user; specify, in response to reception of the start instruction, one or more pieces of event information occurring in the course of the game; specify one or more pieces of notification information to be notified to the user, the notification information including information about a service other than the game; and present, to the user, event history information including the specified event information and the specified notification information as event histories respectively. Here, the “other service” may include a game other than the game, services which the system according to the embodiment provides, and services which the system according to the embodiment does not provide.

Various embodiments of the present disclosure can decrease the sense of discomfort brought to the user of the game when the notification information is presented.

### BRIEF DESCRIPTION OF THE DRAWINGS

FIG. 1 is a configuration diagram schematically illustrating a system 10 according to an embodiment of the disclosure.

FIG. 2 is a block diagram illustrating the functionality of the system 10 according to an embodiment.

FIG. 3 is a flow diagram showing an example of automatic progression process according to an embodiment.

FIG. 4 illustrates an example of a start instruction receiving screen 60 according to an embodiment.

FIG. 5 illustrates an example of event history information screen 70 according to an embodiment.

FIG. 6 illustrates an example of event history information screen 70 according to an embodiment.

FIG. 7 illustrates an example of event history information screen 70 according to an embodiment.

FIG. 8 illustrates an example of event history information screen 70 according to an embodiment.

FIG. 9 illustrates an example of event history information screen 70 according to an embodiment.

### DESCRIPTION OF THE PREFERRED EMBODIMENTS

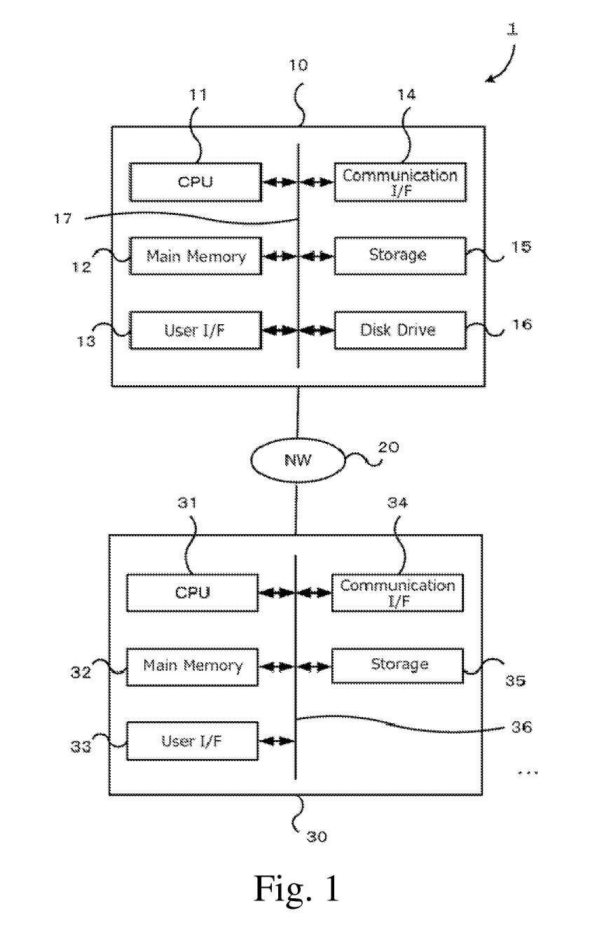

FIG. 1 is a configuration diagram schematically illustrating a system 10 according to an embodiment of the disclosure. The system 10 according to the embodiment is communicatively coupled to a plurality of terminal devices 30 via a communication network 20 such as Internet as illustrated in FIG. 1. The system 10 provides, to a user who is operating the terminal device 30, various electronic contents service including online games, electronic books, video contents, and music contents; a communication platform (SNS platform) for implementing various user-to-user communication features such as chat (mini mail), circle, avatar, diary, message board, greeting, telephone call, etc.; and various Internet services including electronic commerce services, etc.

As illustrated in FIG. 1, the system 10 according to the embodiment is configured as a common computer device and may include a central processing unit (CPU) (computer processor) 11, a main memory 12, a user interface (I/F) 13, a communication I/F 14, a storage 15, and a disk drive 16, and these components may be electrically connected to one another via a bus 17. The CPU 11 may load an operating system and various programs into the main memory 12 from the storage 15, and may execute commands included in the loaded programs. The main memory 12 may be used to store a program to be executed by the CPU 11, and may be formed of, for example, a dynamic random access memory (DRAM). The system 10 according to an embodiment may be configured from computer devices that have the above-described hardware configurations.

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The storage 15 may be formed of, for example, a magnetic disk drive and store a control program for controlling various services and the like. The storage 15 may also store various data used in the various services. The various data that may be stored in the storage 15 may also be stored on a database server communicatively connected to the system 10 and physically separate from the system 10. The disk drive 16 may read data stored in storage medium such as a compact disc read only memory (CD-ROM), digital versatile disc read only memory (DVD-ROM), or DVD Recordable (DVD-R) disc, or write data to such a storage medium.

In an embodiment, the system 10 may function as a web server for managing a web site including a plurality of hierarchical web pages and may be capable of providing the terminal device 30 with various above-mentioned Internet services. The terminal devices 30 may fetch HTML data for rendering a web page from the system 10 and analyze the fetched HTML data to present the web page to a user of the terminal devices 30. The storage 15 may also store the HTML data for rendering the web page. The HTML data may comprise HTML documents written in markup languages such as HTML, the HTML documents may be associated with various images. Additionally, the HTML documents may include programs written in script languages such as ActionScript™ and JavaScript™.

The storage 15 may also store applications to be executed on execution environments of the terminal device 30 other than browser software. These applications may include programs for receiving services and various data such as image data to be referred to for executing the programs. The programs may be created in, for example, object oriented languages such as Objective-C™ and Java™. The created programs may be stored on the storage 15 in the form of application along with various data. The application stored on the storage 15 may be delivered to the terminal device 30 in response to a delivery request. The application delivered from the system 10 may be received by the terminal device 30 through a communication I/F 34 in accordance with the control of CPU 31; and the received program may be sent to a storage 35 and stored thereon. The terminal device 30 may download such applications from systems (application markets) other than the system 10. The application stored in the terminal device 30 may be launched in accordance with the user's operation on the terminal device 30 and may be executed on an execution environment implemented on the terminal device 30 such as ngCore™ or Android™. The system 10 may provide the applications executed on the terminal devices 30 with various data required for providing services. Additionally, the system 10 can store various data sent from the terminal device 30 for each user, thereby managing the providing state of services (e.g., progress state of the game) for each user.

Thus, the system 10 may manage the web site for providing various services and deliver web pages constituting the web site in response to a request from the terminal device 30, thereby providing a service to a user. Also, the system 10 can provide services based on communication with an application performed on the terminal device 30 in place of, or in addition to, such browser-based services. Whichever mode may be taken to provide the services, the system 10 can store data required to provide the services for each identification identifying a user. Briefly, the system 10 may also include a function to authenticate a user at start of provision of services and perform charging process in accordance with provision of services. The games provided by the system 10 may include desired games such as action games, role playing games, interactive sports games, and card games. The types of the games implemented by the system 10 are not limited to those explicitly disclosed herein.

In an embodiment, the terminal device 30 may be any information processing device that may display on a web browser a web page of a game web site for providing services obtained from the system 10 and include an executing environment for executing applications; and the terminal devices 30 may include smartphones, tablet terminals, and game-dedicated terminals.

As shown in FIG. 1, the terminal device 30 may include a central processing unit (CPU) (computer processor) 31, a main memory 32, a user interface (I/F) 33, a communication I/F 34, and a storage 35, and these components may be electrically connected to one another via a bus 36.

The CPU 31 may load an operating system and various programs into the main memory 32 from the storage 35, and may execute commands included in the loaded programs. The main memory 32 may be used to store a program to be executed by the CPU 31, and may be formed of, for example, a dynamic random access memory (DRAM).

The user I/F 33 may include, for example, an information input device such as a touch panel, a keyboard, a button, and a mouse for accepting an input from a user, and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the system 10 via the communication network 20.

The storage 35 may comprise, for example, a magnetic disk drive or a flash memory and store various programs such as an operating system. When receiving an application from a system 10 via the communication I/F 34, the storage 35 may store the received application.

A terminal device 30 having such an architecture may include, for example, browser software for interpreting an HTML file (HTML data) and rendering a screen; this browser software may enable the terminal device 30 to interpret the HTML data fetched from the system 10 and render web pages corresponding to the received HTML data. Further, the terminal device 30 may include plug-in software embedded into browser software; therefore, the terminal device 30 can obtain files embedded in HTML data from the system 10 and execute the files by using the browser software and the plug-in software.

When a service is provided to the terminal device 30, for example, animation or an operation icon designated by the program may be displayed on a screen of the terminal device 30. The user may enter an instruction for receiving the service using an input interface of the terminal device 30. The instruction entered by the user may be transmitted to the system 10 through the browser of the terminal device 30 or a function of an execution environment such as NgCore™.

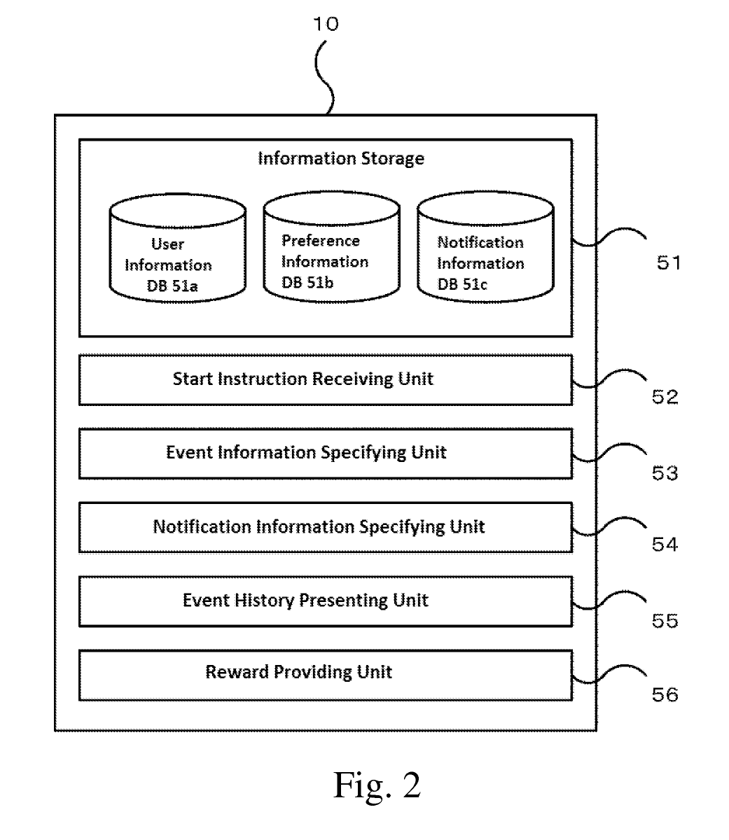

Next, operations of the above-described system 10 according to an embodiment will be now described. Although the system 10 according to the embodiment can provide various Internet services as described above, functionality relating to games with an automatic progression feature where the game progresses without user's operation will be mainly described as an example appropriate for describing the embodiments of the present disclosure. FIG. 2 is a block diagram illustrating the functionality of the system 10 according to an embodiment. As shown in FIG. 2, the system 10 may include an information storage unit 51 storing various information, a start instruction receiving unit 52 receiving a start instruction to start the game from a user, an event information specifying unit 53 specifying, in response to the reception of the start instruction, one or more pieces of event information occurring as the game progresses, and a notification information specifying unit 54 specifying one or more pieces of notification information to be notified to the user including information about services other than the game. The system 10 may further include an event history presenting unit 55 presenting event history information including the specified event information and the specified notification information as event histories to the user, and a reward providing unit 56 providing reward to the user. These functionalities can be realized by cooperatively operating hardware such as the CPU 11 and the main memory 12 of the system 10 and software such as various programs stored in the storage 15 and the like. For example, instructions included in one or more computer programs corresponding to the above-described functionalities respectively are executed by the CPU 11 of the system 10 to realize the above-described functionalities. Here, a part or all of the functionalities or a part of each functionality included in the system 10 may be realized by the terminal device 30. In this case, the functionalities can be realized by, for example, executing instructions included in the corresponding computer programs by the CPU 31 of the terminal device 30.

Referring to FIG. 2, the information storage 51 can be realized with the storage 15 and the like of the system 10. The information storage 51 may include a user information database 51a that manages information about a user, a preference information database 51b that manages information concerning user's preferences for services, and a notification information database 51c that manages notification information to be notified to the user. The user information database 51a may manage various information about a user who uses various services provided by the system 10. An example of the various information may include basic information about the user (user ID, name, contact information, payment information, authentication information, and the like), information about other user relating to the user (for instance, a friend established such that one user sends a friend request and the other user receives and accepts the request) and so on. The preference information database 51b may manage various information about user's preference for services. For example, the preference information database 51b manages age, gender, usage record of services (time when the user used services, frequency and the like).

The notification information database 51c may manage various information to be notified to the user. In an embodiment, the notification information database 51c manages information concerning a recommendation service that recommends (introduces) various services to the user as one of the notification information. More specifically, the notification information database 51c may manage, as the notification information, for example, information concerning the recommended services including certain types of electronic contents services (an electronic books service, a music contents service and the like), certain electronic contents services (a game title A, music of an artist B, and the like), certain communication features in a communication platform service (chat, avatar, and the like), etc. Here, setting of the recommended service to the user can be specified by applying various rules. For example, the setting of the recommended service can be specified to introduce services that correspond to the user's preference based on the information managed in the preference information database 51b. More specifically, services which the user prefers may be determined based on the usage history of the services stored in the preference information database 51b (for example, services which the user use for a longer time period or higher frequencies may be determined as the preferred services), and the recommended service can set other services similar to the determined preferred service as the services to be recommended, or can set other services which other users having the same or similar preferences as those of the user use. Alternatively, other services which other users having a certain relation with the user such as a friend (such information may be managed in the user information database 51a) may be set as the services to be recommended. Moreover, irrespective of the user's preference for services, services common to users (for example, newly released services and the like) may be set as the recommended services. Such settings of the recommended service and registration of the information about the set services to be recommended to the notification information database 51c may be performed at any timing by the system 10 (or with operation by an operator of the system 10).

Moreover, in one embodiment, the notification information database 51c may manage information concerning state of service offering as one of the notification information. More specifically, the information concerning state of service offering may include an incoming notification in a chat feature (mini-mail) which is one of the communication features provided in the communication platform service, a notification that a certain electronic content is now available in the electronic contents service (for example, a certain electronic book in the electronic book service becomes accessible), a notification about a game with automatic progression notifying that progression of the game by the automatic progression has been finished, and the like. Registration of such information about the providing state of service to the notification information database 51c may be performed by the system 10 (or with operation by an operator of the system 10) each time when information to be notified to the user concerning the providing state of service occurs.

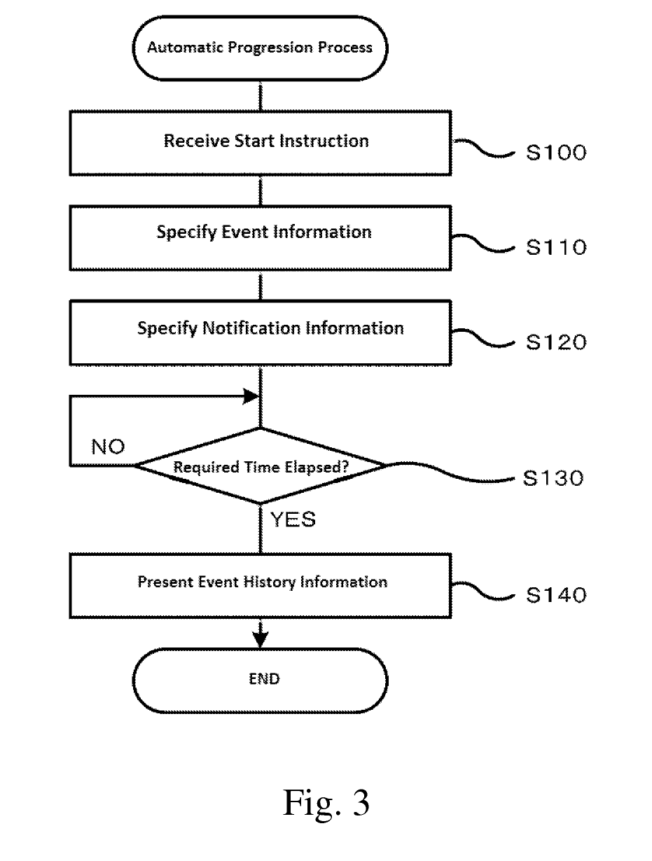

Next, operation of the server 10 according to an embodiment will be described. FIG. 3 shows a flow diagram illustrating an example of automatic progression process performed by the system 10 when a game with the automatic progression feature is provided to a user. The automatic progression process may be performed, for example, when an application corresponding to the game is activated on the terminal device 30 of the user and a menu corresponding to the automatic progression feature is selected.

In the automatic progression process, a start instruction to initiate a game is received from the terminal device 30 of the user as shown in FIG. 3 (step S100). The start instruction receiving unit 52 of the system 10 receives the start instruction. More specifically, the start instruction receiving screen 60 for the user to input the start instruction is displayed on the terminal device 30, and then the start instruction receiving unit 52 receives the start instruction from the user through the start instruction receiving screen 60.

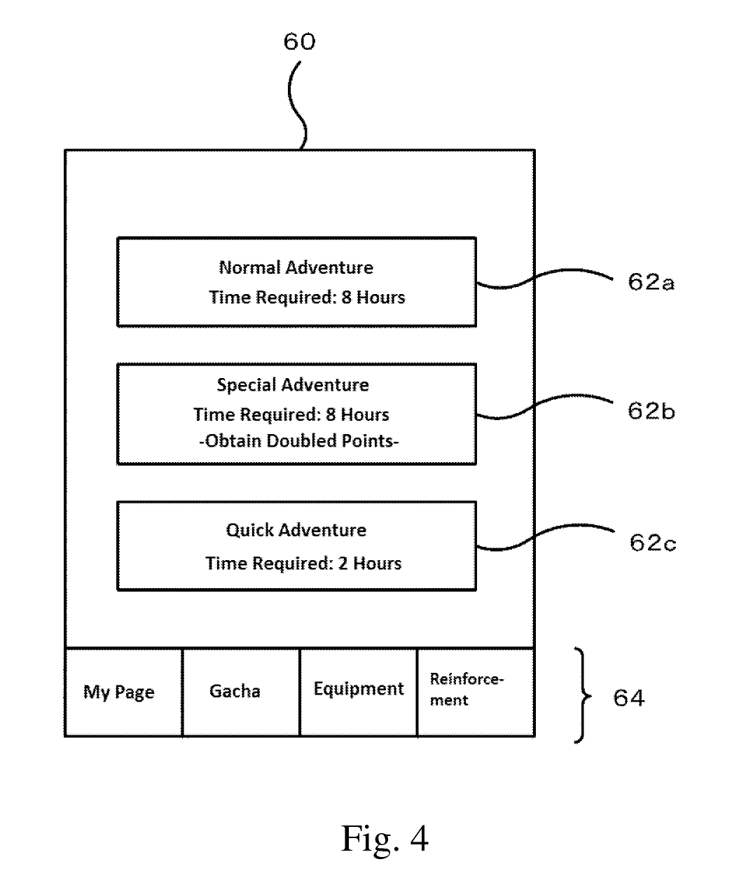

FIG. 4 illustrates an example of the start instruction receiving screen 60 according to an embodiment. As shown in FIG. 4, the start instruction receiving screen 60 has three start instruction buttons 62 (62a, 62b, 62c) through which the user performs the start instruction at the center of the screen. At the lower end of the screen, provided is a basic menu region 64 including a plurality of buttons corresponding to basic menus of the game (for example, a “my-page button” to display a page where the game starts, a “gacha button” to obtain game contents such as cards by lottery, an “equipment button” to set equipments to a character, a “reinforcement button” to perform reinforcement by fusing (synthesizing) two or more cards, and the like. The game of this example has an automatic progression feature where a character automatically explores a game world without operation by the user (hereunder may be referred to as “automatic adventure”), and the three start instruction buttons 62 correspond to different conditions of the automatic adventure. More specifically, conditions of the automatic adventure may include time required to complete the adventure and a game content (for example, points) which a player can obtain during the adventure. For example, time required to complete the adventure is set to eight hours in a “normal adventure” that corresponds to the start instruction button 62a. Whereas in a “special adventure” that corresponds to the start instruction button 62b, time required to complete the adventure may be same as the “normal adventure” but the points which the player can obtain may be set larger (twice) than that of the normal adventure. In a “quick adventure” that corresponds to the start instruction button 62c, the points which the player can obtain may be set as large as that of the “normal adventure” but time required to complete the adventure may be shorter (two hours) than that of the normal adventure. In this example, since the “special adventure” and the “quick adventure” are advantageous for a player (the player can complete the automatic adventure for a shorter time period or the player can obtain more points) compared to the “normal adventure,” the user may be required to consume a game content such as virtual currency, points or the like to select the “special adventure” or the “quick adventure.” In response to selection of the start instruction button 62 by the user, the system 10 (the start instruction receiving unit 52) receives the start instruction for the automatic adventure that follows the condition corresponding to the selected start instruction button 62.

In response to the reception of the start instruction, information about an event to be generated for a character in accordance with the progress of the game may be specified (step S110). The event information specifying unit 53 of the system 10 may specify the event information. The event information can be specified by applying various rules according to the settings of the game. An example of the rules can be such that one or more types of events are randomly selected from predetermined types of events, and event information corresponding to the selected types of events is generated and specified. The types of events occurring to a character may include types of match-up events where the character battles with an opponent character (an opponent player), types of events where the character obtains or consumes points, experience points, coins, items and the like. When event information corresponding to such types of events is generated, determination on a battle result with the opponent, or determination on the contents of the obtained or consumed game contents (values such as points, types such as items and the like) may be performed, and the event information is generated in accordance with the determination results.

Subsequently, notification information to be notified to the user may be specified (step S120). Specifying the event information may be performed by the event information specifying unit 54 of the system 10. In one embodiment, notification information to be notified to the user may be managed at the notification information database 51c as described above. During the automatic progression process, one or more pieces of notification information that corresponds to the user of the terminal device 30 may be selected from the notification information managed at the notification information database 51c to specify the notification information. Selection of the notification information can be performed by applying various rules. For example, a rule where the notification information is randomly selected from the notification information corresponding to the user managed at the notification information database 51c can be applied. In one embodiment, the notification information may be specified based on the event information specified at the step S110. For example, if event information concerning a battle with an opponent is specified, notification information that recommends interactive games similar to the contents of the event information may be specified as the recommended service. If event information concerning the cards which a character obtains is set, notification information that recommends card games similar to the contents of the event information may be specified as the recommended service. In this case, correspondence relations between the types of event information and the notification information are managed in advance (for example, types of the event information corresponding to the notification information are entered in the notification information database 51c), and then notification information can be selected from the notification information corresponding to the specified event information.

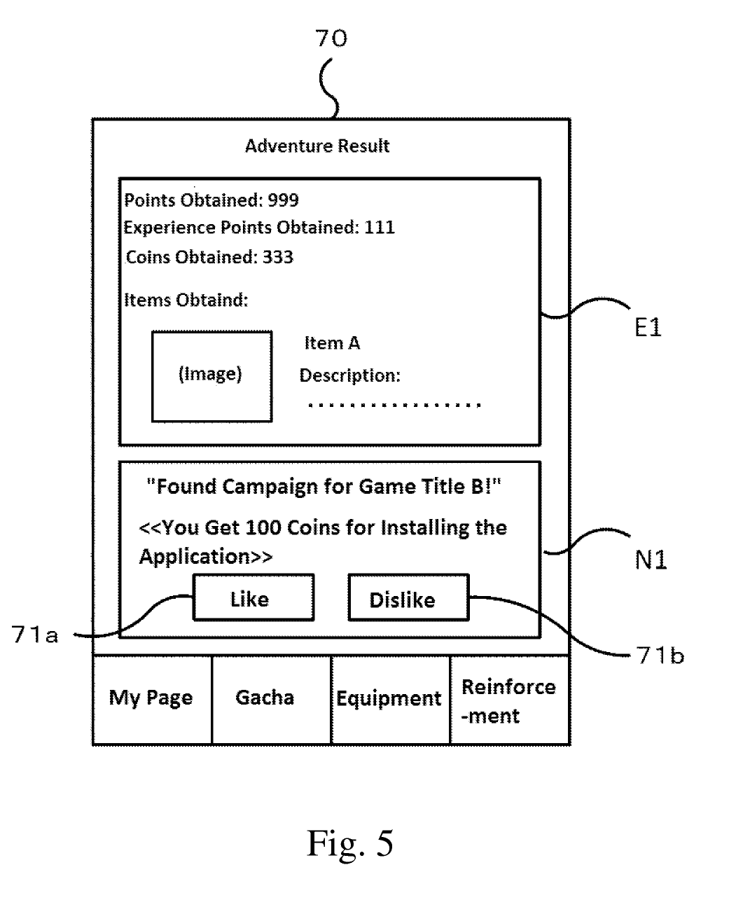

When the time elapsed after the start instruction reception reaches the time required to complete the automatic adventure (step S130), an event history information including the event information and notification information specified in the above-described way as event history may be presented to the user (step S140), and then the automatic progression process is terminated. Presenting the event history information may be performed by the event history presenting unit 55 of the system 10. More specifically, an event history information screen 70 including the event history may be displayed on the terminal device 30. Here, the fact that the event history information screen 70 is displayable after the time required to complete the automatic adventure (the automatic adventure is completed) is elapsed may be notified to the user (for example, a push notification is sent to the terminal device 30 of the user). Various specific examples of the event history information screen 70 will be now described with reference to FIGS. 5-9.

FIG. 5 illustrates an example of the event history information screen 70 displayed on the terminal device 30. On the event history information screen 70, a list of event histories as a result of adventure which a character played is shown. According to the example shown in FIG. 5, the event history includes event information E1 indicating an event where the character obtained a game content, and notification information N1 relating to the recommended service to the user. The event information E1 may be, more specifically, a result of adventure, and facts that a character obtains points, experience points, coins, and items. The notification information N1 may be, more specifically, to notify that there is a campaign for a specific game (a game title B) as the recommended service. The notification information N1 is displayed as an event history generated for a character during adventure. More specifically, the character “found the campaign for the game title B” is shown as the event history. In this manner, according to the embodiment, such notification information that may relate to services other than the game which the user is playing is displayed as the event history generated for the character in the game which the user playing. Therefore, it is possible to reduce the sense of discomfort brought to the user when the notification information is presented. Here, in an embodiment, a link to a page (for example, a page where a corresponding application can be downloaded) of other service (the game title B in the example shown in FIG. 5) corresponding to the notification information may be set in the notification information N1. When a user selects the notification information N1, the linked page is displayed on the terminal device 30.

Moreover, as shown in FIG. 5, the notification information N1 may include information indicating that reward is given to a user if the user uses the recommended service (more specifically, “You get 100 coins for installing the application”). The user can know from the notification information N1 that the reward can be obtained by using the recommended service (installing the corresponding application). In this manner, it is possible to promote the use of the recommended service to the user. The reward given to a user when the user uses the recommended service may include various types of rewards. For example, the reward may be game contents available in the game which the user plays (for example, points, experience points, coins, items, cards, virtual currency and the like), and/or service contents available in the recommended service (for example, points, experience points, coins, items, cards, virtual currency, and other various electronic information corresponding to the content of the service).

Moreover, as shown in FIG. 5, the notification information N1 includes an evaluation button 71 for users to vote their evaluation (a “like” button 71a and a “dislike” button 71b). Through the evaluation button 71, evaluation information about the notification information N1 can be received from users. Here, in one embodiment, when a user votes his/her evaluation for the notification information N1, reward may be given to the user. Giving the reward to the user may be performed by the reward providing unit 56 of the system 10. The reward given to a user when the user votes his/her evaluation may include various types of rewards. For example, game contents available in the game which a user is playing or service contents available in the recommended service can be used as the reward.

Here, in an embodiment, the evaluation information received form a user through the evaluation button 71 may be managed at the preference information database 51b. Moreover, in an embodiment, specifying the notification information performed in the above-described step S120 may be performed based on the evaluation information received in the past from the user. For example, it is possible to increase the likelihood of specifying notification information similar to the contents of the notification information to which a positive evaluation is given by the user (the “like” button 71a is selected). In contrast, it is possible to decrease the likelihood of specifying notification information similar to the contents of the notification information to which a negative evaluation is given by the user (the “dislike” button 71b is selected). Determination of the similarity among the notification information may be performed by applying various rules. For example, notification information may be classified in advance depending on types of services corresponding to the notification information or types of rewards given for the use of the recommended service, and notification information that falls in the same classification may be determined as the similar notification information.

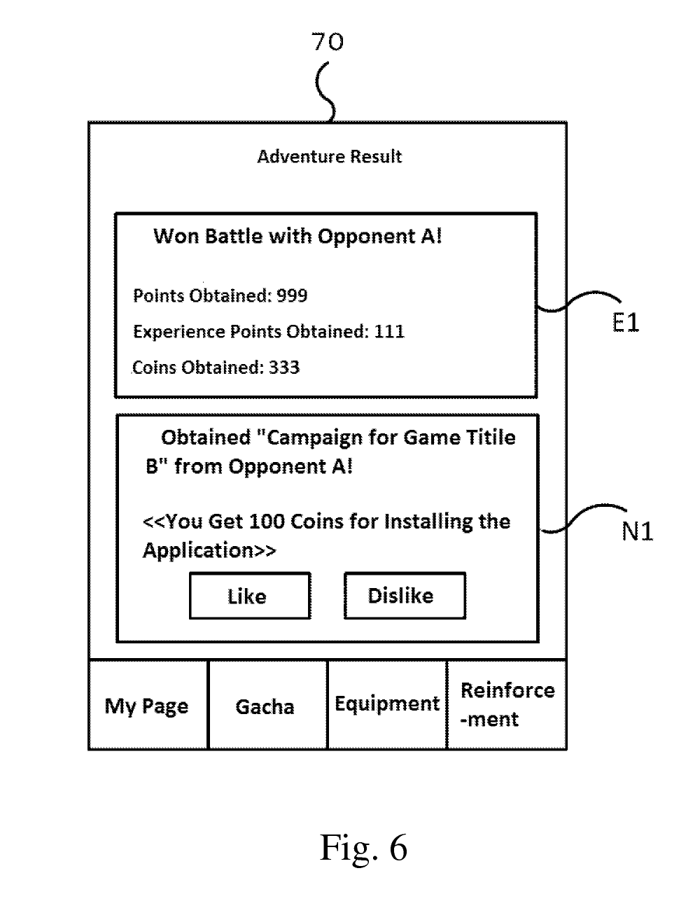

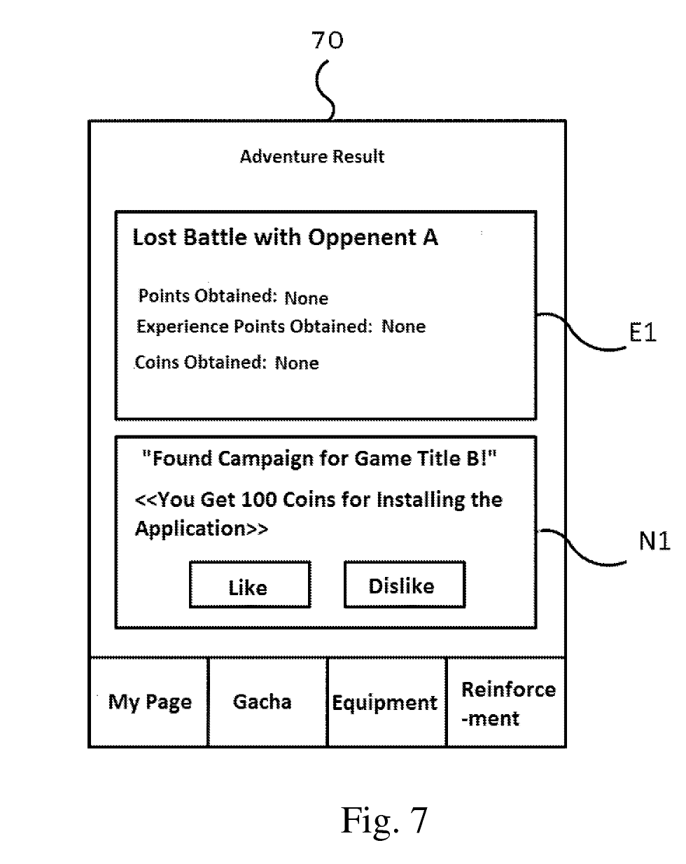

FIGS. 6 and 7 illustrate examples of event history information screen 70 in which the notification information is displayed as an event history of which content is based on event information. Referring to FIG. 6, event information indicating that a character wins a battle with an opponent is set as the event information E1, and the notification N1 indicating “the character obtains campaign for the game title B from the opponent A” (as a result of winning the battle) is displayed as the event history. Referring to FIG. 7, event information indicating that a character loses a battle with an opponent is set as the event information E1, and the notification N1 simply indicating “the character found campaign for the game title B” is displayed as the event history. Here, in one embodiment, even for the notification information with the same content (campaign for the game title B which is recommended), expression of the notification information can be made different in the event history depending on the content of the event information (the result of the battle with the opponent) included in the event history information screen 70. In this manner, it is possible to further decrease the sense of discomfort brought to the user.

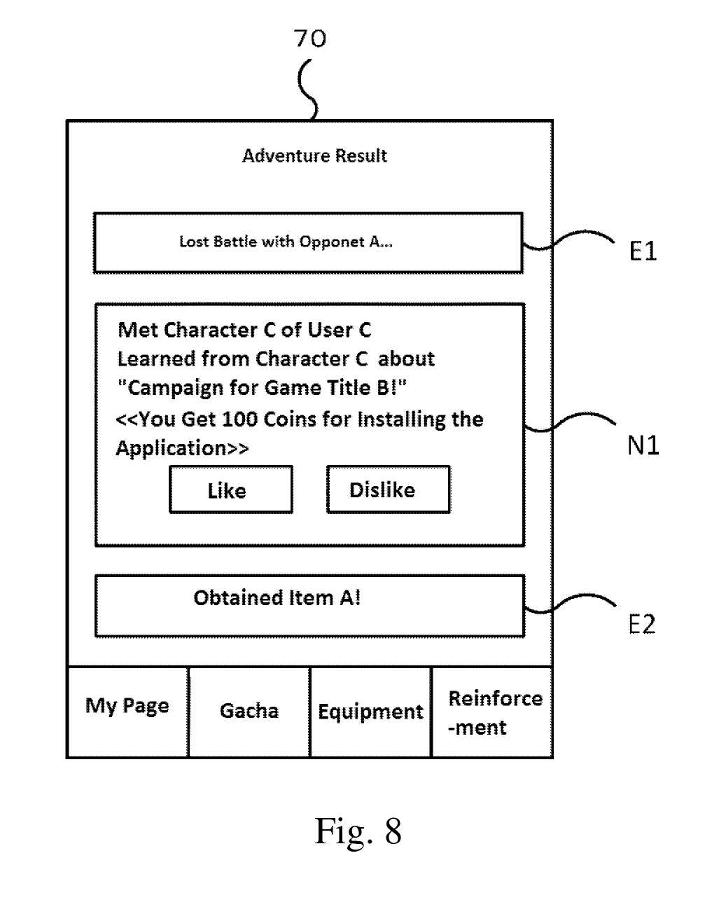

FIG. 8 illustrates another example of the event history information screen 70 displayed on the terminal device 30. In this example shown in FIG. 8, the notification information N1 is provided between the event information E1 indicating a result of a character's battle with an opponent and the event information E2 indicating that the character obtains an item as a game content. Like the notification information N1 in the examples shown in FIGS. 5-7, this notification information N1 is about the ongoing campaign for the recommended service (the game title B) but it may be expressed in the event history as the character “met a character C of a user C, and the character learned about the campaign for the game title B from the character C.” In this manner, the notification information to a user can be shown as the event history which other user mediates (an event in which the character meets (a character) of other user) in one embodiment. In this manner, it is possible to encourage the user to communicate with the other user. Here, the other user who mediates the notification information (the user C in the example shown in FIG. 8) may be a user arbitrarily selected by the system 10 or a user selected among users who have certain relationships such as friend with the user. When the other user who mediates the notification information is set to a user who has a certain relationship such as friend with the user, the user is likely to feel familiar or a sense of trust to the notification information. Moreover, when the notification information relates to a recommended service, the user who mediates the notification information may be preferably a user who uses the recommended service. Furthermore, the system 10 may provide a feature with which a user can recommend a certain service to other users, and the user who mediates the notification information may be set as a user who recommends a service to the user by using this feature.

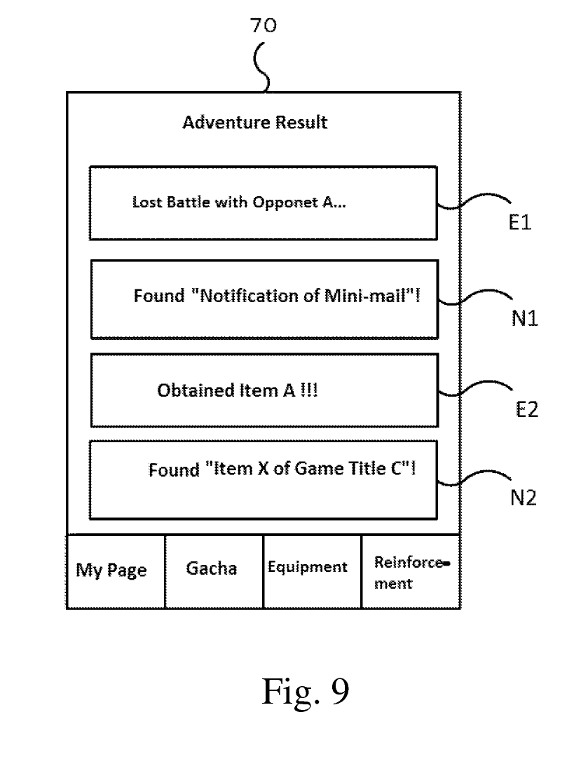

FIG. 9 illustrates another example of the event history information screen 70 displayed on the terminal device 30. In this example shown in FIG. 9, the event history includes event information E1 indicating a result of a character's battle with an opponent, notification information N1 relating to a providing state of other services, event information E2 indicating an event where the character obtained a game content, and notification information N2 relating to the recommended service to the user. The notification information N1 here is information about a providing state of other services, more specifically, incoming notification in a chat feature (mini-mail) which is one of the communication features provided in the communication platform service. This notification information is shown in the event history as the character “found a mini-mail notification.” The notification information N2 here is information indicating that a character obtained a game content (item X) available in a specific game title (game title C) which is the recommended service. This notification information N2 is shown in the event history as the character “found the item X of the game title C.” Accordingly, the user can know from the notification information N2 that the user obtained the game content (the item X) which can be used in the game title C which is the recommended service. In this manner, it is possible to promote the use of the recommended service to the user. On the event history information screen 70 illustrated in FIG. 9, only outlines of the event histories (event information or notification information) are initially listed. When the user selects one of the event histories, another screen that includes detailed information of the event history pops up or the initial screen transitions to this screen.

When the event history information screen 70 is displayed on the terminal device 30 and the automatic progression process is completed in the above-described way, information about the game content which the character have is updated in accordance with the event information occurring for the character (for instance, points are consumed, experience points and an item are obtained). In case of games with the automatic progression feature, for example, a character that is grown up (information about the obtained game content has been updated) through the automatic progression feature can be used in the game which the user needs to operate to progress the game (for example, a battle with a character with other user). Since other processes in the game with the automatic progression feature is conventional to those skilled in the art, further detailed description thereof will be omitted.

Although the notification information is specified in advance and stored in the notification information database 51c, and during the automatic progression process, notification information is selected from the notification information stored in the notification information database 51c in the above-described embodiment, timing to set the notification information is not particularly limited to this. For instance, the notification information can be specified during the automatic progression process without setting and storing the notification information in advance in the notification information database 51c.

According to the above-described embodiment, the system 10 may receive the start instruction to initiate the game from the user. The system 10 may then specify, in response to reception of the start instruction, one or more pieces of event information occurring in the course of the game. The system 10 may further specify one or more pieces of notification information to be notified to the user. The notification information includes information about services other than the game which the user is playing. The system 10 may the present event history information that includes the specified event information and the specified notification information as event histories respectively. In this manner, such notification information that may relate to services other than the game which the user is playing is displayed as the event history together with the event information occurring in the course of the game which the user playing. Therefore, it is possible to reduce the sense of discomfort brought to the user when the notification information is presented.

As an example of the automatic progression feature, the character automatically explores without user's operation in the above-described embodiment. However, games to which the embodiment of the present disclosure can be applied are not limited to this. The embodiment can be applied to various types of games in which event history information including event information occurring in the course of the game is displayed as an event history. For example, the embodiment can also be applied to games where event information is generated for objects other than characters in the course of the game.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

What is claimed is:

1. A system for providing a game to a user, comprising:
one or more computer processors configured to execute instructions,
the one or more computer processors, in response to execution of the instructions, further configured to:
receive a start instruction to initiate the game from the user;
specify, in response to reception of the start instruction, one or more pieces of event information occurring in the course of the game;
specify one or more pieces of notification information to be notified to the user, the notification information including information about a service other than the game; and
present, to the user, event history information including the specified event information and the specified notification information as event histories respectively, wherein presenting the event history information includes displaying an event history information screen including the event histories and configured to receive evaluation for at least the notification information by the user, and specifying the notification information includes specifying the notification information to be notified to the user based at least on the evaluation received from the user in the past.

2. The system of claim 1 wherein the game uses a character, the event information is information about an event generated for the character, and the event history is a history related to the event generated for the character.

3. The system of claim 2 wherein the character obtains or consumes a game content in the course of the game, and the event information includes information about an event in which the character obtains or consumes the game content.

4. The system of claim 1 wherein the one or more computer processors, in response to execution of the instructions, further configured to provide a prescribed reward to the user from which the evaluation is received.

5. The system of claim 1, further comprising:
a storage device configured to store at least preference information about the user's preference for services,
wherein specifying the notification information includes specifying, as the notification information, information about a recommended service which is the specified other service to be recommended to the user based on the preference information.

6. The system of claim 5, wherein
the information about the recommended service includes information notifying to the user that the user has obtained or is capable of obtaining a service content usable in the recommended service.

7. The system of claim 1, wherein the notification information includes information about a providing state of the other service.

8. The system of claim 1, wherein specifying the notification information includes specifying the notification information based on the specified event information.

9. The system of claim 1, wherein presenting the event history information includes presenting the notification information as the event history whose content is based on the event information included in the event history information.

10. The system of claim 1, wherein presenting the event history information includes presenting the notification information as the event history in which the notification information is mediated by another user.

11. A method using one or more computers for providing a game to a user, comprising:
receiving a start instruction to initiate the game from the user;
specifying, in response to reception of the start instruction, one or more pieces of event information occurring in the course of the game;
specifying one or more pieces of notification information to be notified to the user, the notification information including information about a service other than the game; and
presenting, to the user, event history information including the specified event information and the specified notification information as event histories respectively,
wherein presenting the event history information includes displaying an event history information screen including the event histories and configured to receive evaluation by the user for at least the notification information, and specifying the notification information includes specifying the notification information to be notified to the user based at least on the evaluation received from the user in the past.

12. A computer-readable storage medium storing a program for providing a game to a user, the program causing one or more computers to:
receive a start instruction to initiate the game from the user;
specify, in response to reception of the start instruction, one or more pieces of event information occurring in the course of the game;
specify one or more pieces of notification information to be notified to the user, the notification information including information about a service other than the game; and
present, to the user, event history information including the specified event information and the specified notification information as event histories respectively,
wherein presenting the event history information includes displaying an event history information screen including the event histories and configured to receive evaluation by the user for at least the notification information, and specifying the notification information includes specifying the notification information to be notified to the user based at least on the evaluation received from the user in the past.
